(19) United States
(12) Patent Application Publication
(10) Pub. No.: US 2008/0198635 A1
(43) Pub. Date: Aug. 21, 2008

(54) Pulse width modulated ground/return for powered device

(75) Inventors: Asif Hussain, Tustin, CA (US); Manisha Pandya, Anaheim Hills, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/907,286

(22) Filed: Oct. 10, 2007

Related U.S. Application Data
(60) Provisional application No. 60/902,335, filed on Feb. 21, 2007.

(51) Int. Cl. H02M 3/335

(52) U.S. Cl. 363/21.11

(57) ABSTRACT

A new pulse width modulation return scheme in which the source of PWM FET is directly connected to the 48 Volt return and therefore Ids of PWM FET does not pass through the hot-swap FET which therefore significantly reduce the power dissipation on the die of PD chip.

### CROSS REFERENCE TO RELATED APPLICATIONS

This application claims benefit of U.S. Provisional Application No. 60/902,335, filed Feb. 21, 2007, which is incorporated herein by reference in its entirety.

### FIELD OF THE INVENTION

The present invention is generally directed to communication systems. More particularly, the invention relates to powered devices in Power over Ethernet (PoE) communication systems.

### BACKGROUND OF THE INVENTION

Ethernet communications provide high speed data communications via a communications medium between two nodes. The communications medium may be twisted pair wires for Ethernet, or another type of communications medium that is appropriate. The Ethernet communications operate according the IEEE 802 Ethernet Standard. One type of Ethernet communications system is a Power over Ethernet (PoE) system. PoE communication systems provide both power and high-speed data communications over a common communications medium. More specifically, power source equipment (PSE) connected to a physical layer of a first node of the communications medium provides DC power (for example, 48 volts DC) to a powered device (PD) at a second node of the communications medium. Thus, the DC power is transmitted simultaneously over the same communications medium with the high-speed data from the first node to the second node. Exemplary PD devices include Internet Protocol (IP) phones, wireless access points, etc.

The PD has a DC-to-DC converter that reduces a voltage supplied by the PSE to meet voltage requirements of PD circuits. One method to reduce a DC voltage is with a DC-to-DC converter that uses pulse width modulation (PWM). The DC-to-DC converter has a transformer, PWM FET, and PWM sensing resistor connected in series. The DC-to-DC converter operates in three steps. First, the DC-to-DC converter converts the voltage supplied by the PSE to a PWM signal by repeatedly switching the PWM FET on and off. A PWM current of the PWM signal passes through the sensing resistor. A PD controller senses a voltage drop across the sensing resistor to determine the PWM current. The PD controller uses the PWM current to determine a duty cycle of the PWM FET. Second, the PWM signal passes through a first winding of the transformer and creates a magnetic field of varying strength. Finally, a second transformer winding converts the magnetic field to a transformer output. The transformer output is rectified to power the PD. The PWM current returns from the first winding to the communications medium via a hot-swap FET.

A capacitor connected in parallel with the DC-to-DC converter maintains a constant voltage input to the DC-to-DC converter. The capacitor charges when the PD initially connects to the communications medium. Thus, an inrush current flows when the PD initially connects. If left unchecked, the inrush current exceeds a current-supply capacity of the PSE and may cause the PSE to fail. For example, the PSE current-supply capacity is a maximum of 450 mA of inrush current for 50 mS. To minimize PSE failure, the PD contains a hot swap FET connected in series with the DC-to-DC converter. The hot swap FET limits inrush current to protect the PSE and is integrated with the PD controller. The PD controller controls the hot swap FET based on a measurement of inrush current through the sensing resistor.

With the typical PD design, the PD controller wastes power and becomes hot. Both the inrush current and the PWM current pass through the hot swap FET in the typical PD controller. After the inrush current stops, PWM current continues to flow through the hot swap FET. Further, even while conducting, the hot swap FET provides some resistance to the PWM current. The resistance of the hot swap FET, and thus the PD controller, dissipates some of the PWM current in the form of heat. Thus, the PD controller wastes power and becomes hot. Additionally, the wasted power cannot be used elsewhere in the PD, such as by the load. Thus, the typical PD design heats the PD controller and is inefficient.

Accordingly, what is needed is a circuit that reduces power dissipation of the PD controller as well as overcoming other shortcomings described above.

### BRIEF SUMMARY OF THE INVENTION

In an embodiment, a pulse width modulated return circuit for a powered device has a first transformer having a first and second tap as well as a sensing resistor coupled between the second tap and a node. A capacitor and a first FET are series coupled between the first tap and the node. The first FET is part of a powered device controller. The pulse width modulated return circuit for a powered device also has a second transformer having a winding and a second FET series coupled with the winding between the first tap and the node.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and enable a person skilled in the pertinent art to make and use the invention.

In the drawings:

FIG. 1 is a block diagram of a Power over Ethernet (PoE) system.

FIG. 2 illustrates a detailed figure showing power transfer from the Power Source Equipment (PSE) to the Powered Device (PD) in the 10/100-Base-T PoE system.

FIG. 3 illustrates an exemplary embodiment of a PD having a typical pulse width modulated (PWM) return circuit.

FIG. 4 illustrates another exemplary embodiment of a PD having a PWM return circuit.

FIG. 5 illustrates a detailed exemplary embodiment of a PD having a PWM return circuit.

FIG. 6 illustrates another detailed exemplary embodiment of a PD having a PWM return circuit.

FIG. 7 shows an exemplary method to control a PD.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

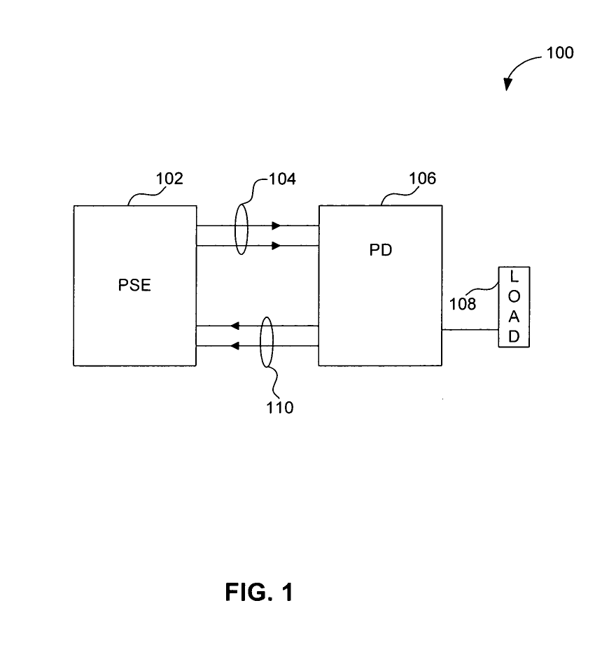

The invention provides an approach to reducing power dissipation of a powered device controller. FIGS. 1-7, described below, illustrate this approach. This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

FIG. 1 illustrates a high level diagram of a conventional Power over Ethernet (PoE) system 100 that provides both DC power and data communications over a common data communications medium. Referring to FIG. 1, power source equipment (PSE) 102 provides DC power over conductors 104, 110 to a powered device (PD) 106 having a representative electrical load 108. The PSE 102 and PD 106 also include data transceivers that operate according to a known communications standard, such as the IEEE Ethernet standard. More specifically, the PSE 102 includes a physical layer device that transmits and receives high speed data with a corresponding physical layer device in the PD 106, as will be discussed further below. Accordingly, the power transfer between the PSE 102 and the PD 106 occurs simultaneously with the exchange of high speed data over the conductors 104, 110. In one example, the PSE 102 is a data switch having multiple ports that is communication with one or more PD device 106, such as an Internet phone or a wireless access point.

The conductor pairs 104 and 110 can carry high speed differential data communications. In one example, the conductor pairs 104 and 110 each include one or more twisted wire pairs, or any other type of cable or communications media capable of carrying the data transmissions and DC power transmissions between the PSE 102 and the PD 106. In Ethernet communications, the conductor pairs 104 and 110 can include multiple twisted pairs, for example four twisted pairs for 1 Gigabit Ethernet. In 10/100 Ethernet, only two of the four pairs carry data communications, and the other two pairs of conductors are unused. Herein, conductor pairs may be referred to as Ethernet cables or communication links for ease of discussion.

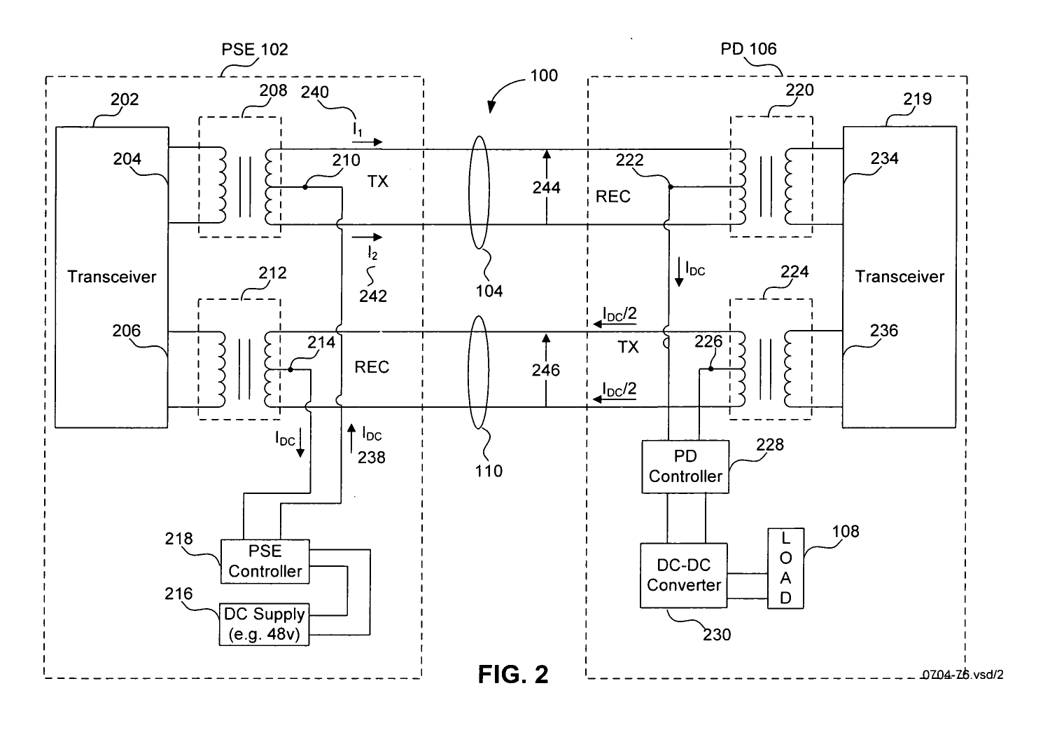

FIG. 2 provides a more detailed circuit diagram of the PoE system 100, where the PSE 102 provides DC power to the PD 106 over the conductor pairs 104, 110. The PSE 102 includes a transceiver physical layer device (or PHY) 202 having full duplex transmit and receive capability through a differential transmit port 204 and a differential receive port 206. Herein, a transceiver may be referred to as a PHY. A first transformer 208 couples high speed data between the transmit port 204 and the first conductor pair 104. Likewise, a second transformer 212 couples high speed data between the receive port 206 and the second conductor pair 110. The respective transformers 208 and 212 pass the high speed data to and from the transceiver 202, but isolate any low frequency or DC voltage from the transceiver ports, which may be sensitive large voltage values.

The first transformer 208 includes a primary and a secondary winding, where the secondary winding (on the conductor side) includes a center tap 210. Likewise, the second transformer 212 includes a primary and a secondary winding, where the secondary winding (on the conductor side) includes a center tap 214. The PSE Controller 218 connects a voltage that is applied across the respective center taps of the transformers 208 and 210 on a side of the transformers 108 and 212 coupled to the conductor pairs 104 and 110. The center tap 210 is coupled to a first output of a DC PSE Controller 218, and the center tap 214 is coupled to a second output of the PSE Controller 218. As such, the transformers 208 and 212 isolate the DC voltage supplied by the PSE Controller 218 from the sensitive data ports 204, 206 of the transceiver 202. An example DC output voltage supply 216 is 48 volts, but other voltages could be used depending on the voltage or power requirements of the PD 106 and the voltage range defined by the applicable standard.

The PSE 102 includes a PSE controller 218 that controls the DC voltage supply 216 based on dynamic power requirements of the PD 106. More specifically but not limited to, the PSE controller 218 measures the voltage, current, and temperature of the Outgoing and incoming DC supply lines so as to characterize the power requirements of the PD 106.

Further, the PSE controller 218 detects and validates a compatible PD 106, determines a power classification signature for the validated PD 106, supplies power to the PD 106, monitors the power, and reduces or removes the power from the PD 106 when the power is no longer requested or required. During detection, if the PSE 102 finds the PD 106 to be non-compatible, the PSE 102 may prevent the application of power to the PD 106, thus protecting the PD 106 from possible damage. IEEE has imposed standards on the detection, power classification, and monitoring of the PD 106 by the PSE 102 in the IEEE 802.3af™ standard, which is incorporated herein by reference. A new IEEE standard (802.3 at) is in the formative stage at this time which will impose similar requirements on the detection, classification, etc.

Still referring to FIG. 2, the contents and functionality of the PD 106 will now be discussed. The PD 106 includes a transceiver physical layer device 219 having full duplex transmit and receive capability through differential transmit port 236 and differential receive port 234. A third transformer 220 couples high speed data between the first conductor pair 104 and the receive port 234. Likewise, a fourth transformer 224 couples high speed data between the transmit port 236 and the second conductor pair 110.

The respective transformers 220 and 224 pass the high speed data to and from the transceiver 219, but isolate any low frequency or DC voltage from the sensitive transceiver data ports 234, 236.

The third transformer 220 includes a primary and a secondary winding, where the secondary winding (on the conductor side) includes a center tap 222. Likewise, the fourth transformer 224 includes a primary and a secondary winding, where the secondary winding (on the conductor side) includes a center tap 226. The center taps 222 and 226 receive the fed DC power carried over conductors 104 and 106 to the representative load 108 of the PD 106, where the load 108 represents a dynamic load of the PD 106. A DC-DC converter 230 is inserted before the load 108 to step down the DC voltage as necessary to meet the voltage requirements of the PD 106. Further, multiple DC-DC converters 230 may be arrayed in parallel to output multiple different voltages (e.g. 3.3 volts, 5 volts, and 12 volts) to supply different loads 108 of the PD 106.

The PD 106 further includes a PD controller 228 that monitors the voltage and current on the PD 106 side of the PoE configuration. The PD controller 228 further provides necessary impedance signatures on the return conductor 110 during initialization, so that the PSE controller 218 will recognize the PD 106 as a valid PoE device, and be able to classify its power requirements.

During ideal operation, a direct current (I_{DC}) 238 flows from the PSE Controller 218 through the first center tap 210, and divides into a first current (I₁) 240 and a second Current (I₂) 242 that is carried over the conductor pair 104. The first current (I₁) 240 and the second current (I₂) 242 then recombine at the third center tap 222 to reform the direct current (I_{DC}) 238 to power the load 108. On return, the direct current (I_{DC}) 238 flows from the load 108 through the fourth center tap 226, and divides for transport over the conductor pair 110. The return DC current recombines at the second center tap 214, and returns to the DC power supply 216. As discussed above, data transmission between the PSE 102 and the PD 106 occurs simultaneously with the DC power supply described above. Accordingly, a first communication signal 244 and/or a second communication signal 246 are simultaneously differentially carried via the conductor pairs 104 and 110 between the PSE 102 and the PD 106 during the supply of DC power. It is important to note that the communication signals 244 and 246 are differential signals that ideally are not effected by the DC power transfer.

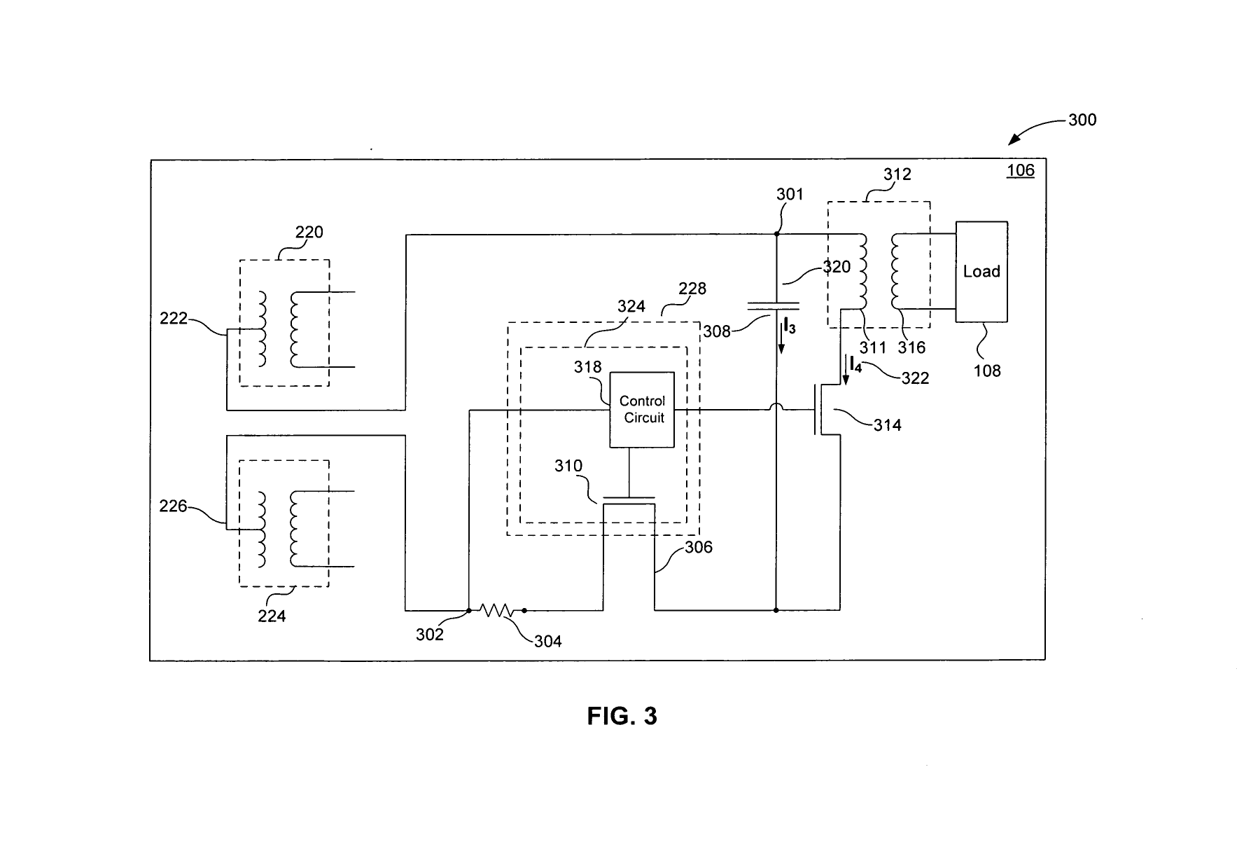

FIG. 3 illustrates an exemplary embodiment of the PD 106 having a pulse width modulated (PWM) return circuit 300. The third center tap 222 is coupled to a first node 301. The fourth center tap 226 is coupled to a second node 302. A sensing resistor 304 is coupled between the second node 302 and a third node 306. A capacitor 308 and a hot-swap FET 310 are coupled in series between the first node 301 and the third node 304. A first winding 311 of a load transformer 312 and a PWM FET 314 are coupled in series between the first node 301 and the third node 306. A second winding 316 of the load transformer 312 is coupled to the load 108. In an example, at least a part of the PD controller 228 including the hot swap FET 310 is deposited on a substrate 324. The sensing resistor 304 may be deposited on the substrate 324 with the PD controller 228 or may be a discrete, non-integrated component. In an example, the FETs described herein are MOSFETs.

The PD controller 228 has a control circuit 318 that is coupled to a gate of the hot swap FET 310 via a gate driver. The control circuit 318 is also coupled to a gate of the PWM FET 314 via another gate driver which is coupled across the sensing resistor 304 via the second node 302 and the third node 306. In examples, the PD controller 228 is coupled to other circuits in the PD 106.

The PD controller 228 manages functions performed by circuits in the PD 106. In examples, the PD controller 228 is a logic circuit and/or a processor. The PD controller 228 may have a computer-readable medium carrying at least one instruction for execution by at least one processor to perform a method for controlling and managing the PD 106. In other examples, the PD controller 228 has a computer-readable medium carrying at least one instruction for execution by at least one processor to perform a method for reducing power dissipation of the PD controller 228.

The third center tap 222 and the fourth center tap 226 provide a supply and return for the direct current (I_{DC}) 238 via, respectively, the third transformer 220 and the fourth transformer 224. When charged, the capacitor 308 maintains a substantially constant voltage across the first winding 311 and the PWM FET 314. The hot swap FET 310 limits inrush current (I₃) 320 during initial charging of the capacitor 308. For example, the capacitor 308 initially charges when the conductors 104, 110 transition from being decoupled from the third transformer 220 and the fourth transformer 224 to being coupled to the third transformer 220 and the fourth transformer 224. In other words, the capacitor 308 charges when one end of an Ethernet cable is plugged into the PD 106 and the other end of the Ethernet cable is plugged into the PSE 102.

The control circuit 318 controls the hot swap FET 310 to limit the inrush current (I₃) 320 to protect the PSE 102. The control circuit 318 measures a voltage across the sensing resistor 304 to determine a magnitude of the inrush current (I₃) 320. When a voltage drop across the sensing resistor 304 is high, which indicates the inrush current (I₃) 320 may damage the PSE 102, the control circuit 318 actuates the hot swap FET 310 to reduce a conductivity of the hot swap FET 310. Thus, the hot swap FET 310 limits the magnitude of the inrush current (I₃) 320. During flow of the inrush current (I₃) 320, the control circuit 318 turns the PWM FET 314 off to eliminate an alternate inrush current (I₃) 320 path. After the inrush current (I₃) 320 period is over, the control circuit 318 causes the hot swap FET 310 to conduct, thus the capacitor 308 is charged and maintains a substantially constant voltage across the first winding 311 and the PWM FET 314.

After the inrush current (I₃) 320 period is over, the PD controller 228 starts DC-to-DC conversion. During DC-to-DC conversion, the control circuit 318 controls the conductivity of the PWM FET 314 to vary a PWM current (I₄) 322 flowing through the first winding 311. The magnitude of the PWM current (I₄) 322 is measured as a voltage across the sensing resistor 304 and is a basis, at least in part, for actuation of the PWM FET 314. Varying a duty cycle of the PWM FET 314 changes a magnitude of the PWM current (I₄) 322. When the magnitude of the PWM current (I₄) 322 varies over time, the transformer 312 magnetically couples energy from the first winding 311 to the second winding 316. The second winding 316 powers the load 108. During DC-to-DC conversion, the hot swap FET 310 conducts while the PWM FET 314 cycles. At no time does the PWM current (I₄) 322 flow through the hot swap FET 310. Further, the control circuit 318 measures both the inrush current (I₃) 320 and the PWM current (I₄) 322 by determining a voltage drop across the sensing resistor 304.

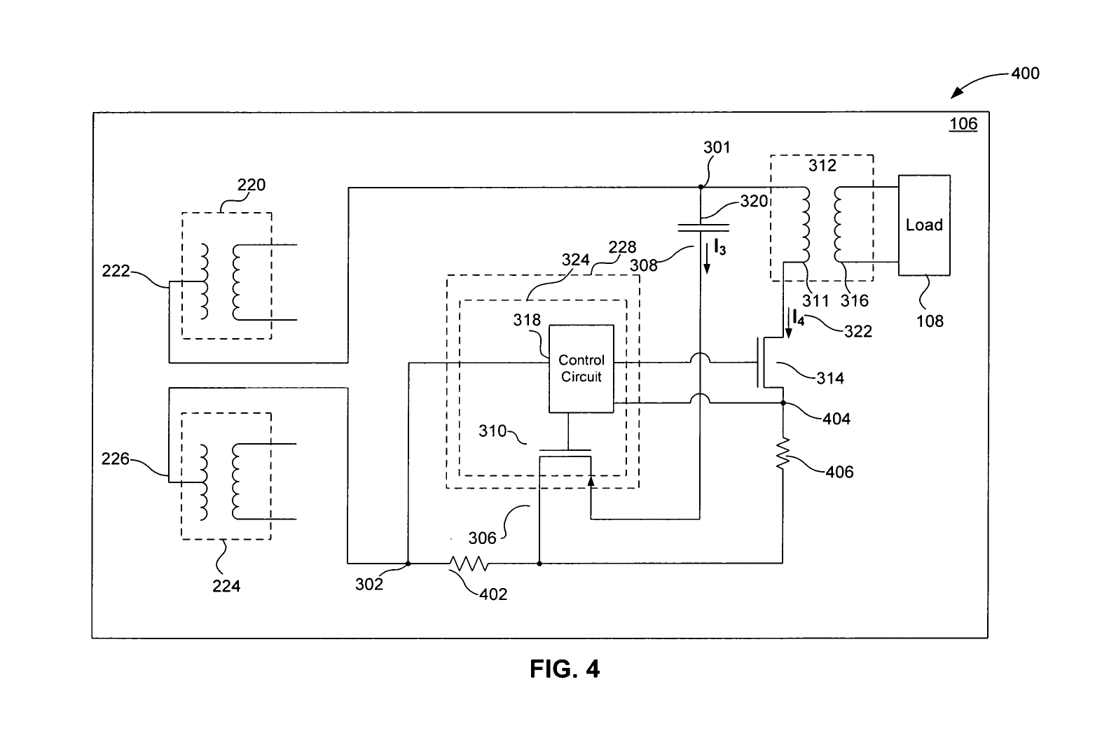

FIG. 4 illustrates another exemplary embodiment of the PD 106 having a pulse width modulated (PWM) return circuit 400. An inrush current sensing resistor 402 is coupled between the second node 302 and a third node 306. The first winding 311 of the load transformer 312 and the PWM FET 314 are coupled in series between the first node 301 and a fourth node 404. A PWM sensing resistor 406 is coupled between the fourth node 404 and the node 306. The control circuit 318 is coupled across the inrush current sensing resistor 402 via the second node 302 and the third node 306. The control circuit 318 is also coupled across the PWM sensing resistor 406 via the node 306 and the fourth node 404. In an example, the inrush current sensing resistor 402 is deposited on the substrate 324 with the PD controller 228. Alternatively, the inrush current sensing resistor 402 is not located on the substrate 324 and is a discrete, non-integrated component.

Still referring to FIG. 4, the third center tap 222 and the fourth center tap 226 provide a supply and return for the direct current (I_{DC}) 238 via, respectively, the third transformer 220 and the fourth transformer 224. When charged, the capacitor 308 maintains a substantially constant voltage across the first winding 311 and the PWM FET 314. The hot swap FET 310 limits inrush current (I₃) 320 during initial charging of the capacitor 308. For example, the capacitor 308 initially charges when the conductors 104, 110 transition from being decoupled from the third transformer 220 and the fourth transformer 224 to being coupled to the third transformer 220 and the fourth transformer 224. In other words, the capacitor 308 charges when one end of an Ethernet cable is plugged into the PD 106 and the other end of the Ethernet cable is plugged into the PSE 102.

The control circuit 318 controls the hot swap FET 310 to limit the inrush current (I₃) 320 to protect the PSE 102. The control circuit 318 measures a voltage across the inrush current sensing resistor 402 to determine a magnitude of the inrush current (I₃) 320. When a voltage drop across the inrush current sensing resistor 402 is high, which indicates the inrush current (I₃) 320 may damage the PSE 102, the control circuit 318 actuates the hot swap FET 310 to reduce a conductivity of the hot swap FET 310. Thus, the hot swap FET 310 limits the magnitude of the inrush current (I₃) 320. During flow of the inrush current (I₃) 320, the control circuit 318 turns the PWM FET 314 off to eliminate an alternate inrush current (I₃) 320 path. After the inrush current (I₃) 320 period is over, the control circuit 318 causes the hot swap FET 310 to conduct, thus the capacitor 308 is charged and maintains a substantially constant voltage across the first winding 311 and the PWM FET 314.

After the inrush current (I₃) 320 period is over, the PD controller 228 starts DC-to-DC conversion. During DC-to-DC conversion, the control circuit 318 controls the conductivity of the PWM FET 314 to vary a PWM current (I₄) 322 flowing through the first winding 311. The control circuit 318 measures a voltage across the PWM sensing resistor 406 to determine the magnitude of the PWM current (I₄) 322. The magnitude of the PWM current (I₄) 322 is a basis, at least in part, for actuation of the PWM FET 314. Varying a duty cycle of the PWM FET 314 changes a magnitude of the PWM current (I₄) 322. When the magnitude of the PWM current (I₄) 322 varies over time, the transformer 312 magnetically couples energy from the first winding 311 to the second winding 316. The second winding 316 powers the load 108. Thus, during DC-to-DC conversion, the hot swap FET 310 conducts while the PWM FET 314 cycles. At no time does the PWM current (I₄) 322 flow through the hot swap FET 310.

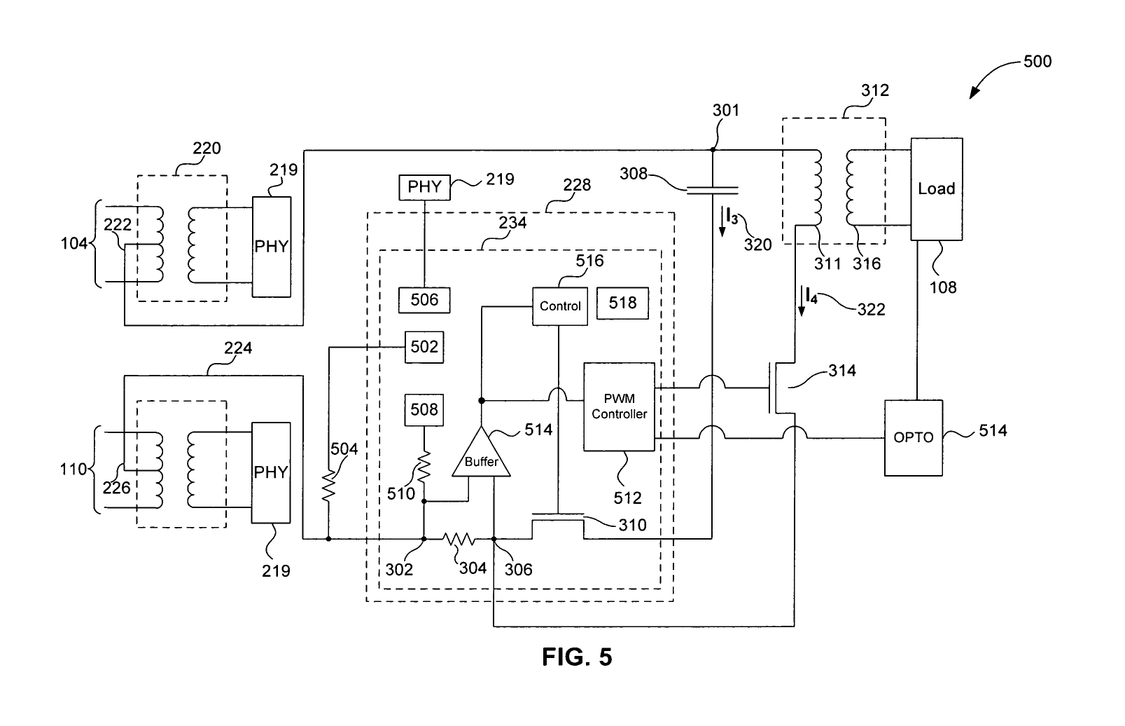

FIG. 5 illustrates a detailed exemplary embodiment of the PD 106 having a pulse width modulated (PWM) return circuit 500. The PWM return circuit 500 example includes circuits for classification, detection, control of the hot swap FET 310 control, and control of the PWM FET 314. A classification circuit 502 is part of the PD controller 228 and is coupled to the second node 302 via a classification resistor 504. The classification circuit 502 and the classification resistor 504 assist the PSE 102 in determining a power class of the PD 106 by constant current source that classification current is measured by the PSE 102

A detection circuit 508 is also part of the PD controller 228 and is coupled via a signature resistor 510 to the second node 302. The detection circuit 508 and the signature resistor 510 assist the PSE 102 in determining if the PD 106 is a valid device. The signature resistor 510 is deposited on the substrate 324 with the PD controller 228. Alternatively, the signature resistor 510 may be a discrete, non-integrated, component.

Still referring to FIG. 5, the third center tap 222 and the fourth center tap 226 provide a supply and return for the direct current (I_{DC}) 238 via, respectively, the third transformer 220 and the fourth transformer 224. When charged, the capacitor 308 maintains a substantially constant voltage across the first winding 311 and the PWM FET 314. The hot swap FET 310 limits inrush current (I₃) 320 during initial charging of the capacitor 308. For example, the capacitor 308 initially charges when the conductors 104, 110 transition from being decoupled from the third transformer 220 and the fourth transformer 224 to being coupled to the third transformer 220 and the fourth transformer 224. In other words, the capacitor 308 charges when one end of an Ethernet cable is plugged into the PD 106 and the other end of the Ethernet cable is plugged into the PSE 102.

The hot swap FET control circuit 516 controls the hot swap FET 310 to limit the inrush current (I₃) 320 to protect the PSE 102. The hot swap FET control circuit 516 receives a signal from a buffer 514. The buffer 514 measures a voltage across the sensing resistor 304 to determine a magnitude of the inrush current (I₃) 320. When a voltage drop across the sensing resistor 304 is high, which indicates the inrush current (I₃) 320 may damage the PSE 102, the hot swap FET control circuit 516 actuates the hot swap FET 310 to reduce the conductivity of the hot swap FET 310. Thus, the hot swap FET 310 limits the magnitude of the inrush current (I₃) 320. During flow of the inrush current (I₃) 320, a PWM controller 512 turns the PWM FET 314 off to eliminate an alternate inrush current (I₃) 320 path. After the inrush current (I₃) 320 period is over, the hot swap FET control circuit 516 causes the hot swap FET 310 to conduct, thus the capacitor 308 is charged and maintains a substantially constant voltage across the first winding 311 and the PWM FET 314.

After the inrush current (I₃) 320 stops, the PD controller 228 starts DC-to-DC conversion with the PWM controller 512 that is coupled to the PWM FET 314. The PWM controller 512 controls the switching state of the PWM FET 314. An input to the PWM controller 512 is a buffer 514. The buffer 514 has a first input coupled to the second node 302 and a second input coupled to the third node 306. Thus, two inputs to the buffer 514 are coupled across the sensing resistor 304. A second input to the PWM controller 512 is an opto-electric coupler 520 that provides feedback about power consumption of the load 108.

During DC-to-DC conversion, the PWM controller 512 controls the conductivity of the PWM FET 314 to vary a PWM current (I₄) 322 flowing through the first winding 311. The PWM controller 512 receives a signal from the buffer 514 indicating the magnitude of the PWM current (I₄) 322. The magnitude of the PWM current (I₄) 322 is a basis, at least in part, for actuation of the PWM FET 314. Varying the duty cycle of the PWM FET 314 changes a magnitude of the PWM current (I₄) 322. When the magnitude of the PWM current (I₄) 322 varies over time, the transformer 312 magnetically couples energy from the first winding 311 to the second winding 316. The second winding 316 powers the load 108. Thus, during DC-to-DC conversion, the hot swap FET 310 conducts while the PWM FET 314 cycles. At no time does the PWM current (I₄) 322 flow through the hot swap FET 310.

The PD controller 228 may have a digital control circuit 506 to control circuits within the PD controller 228. The digital control circuit 506 is coupled to the transceiver physical layer device 219. The digital control circuit 506 may also be coupled to at least one of the classification circuit 502, the detection circuit 508, the PWM controller 512, the buffer 514, the hot swap FET control circuit 516, and a thermal protection circuit 518.

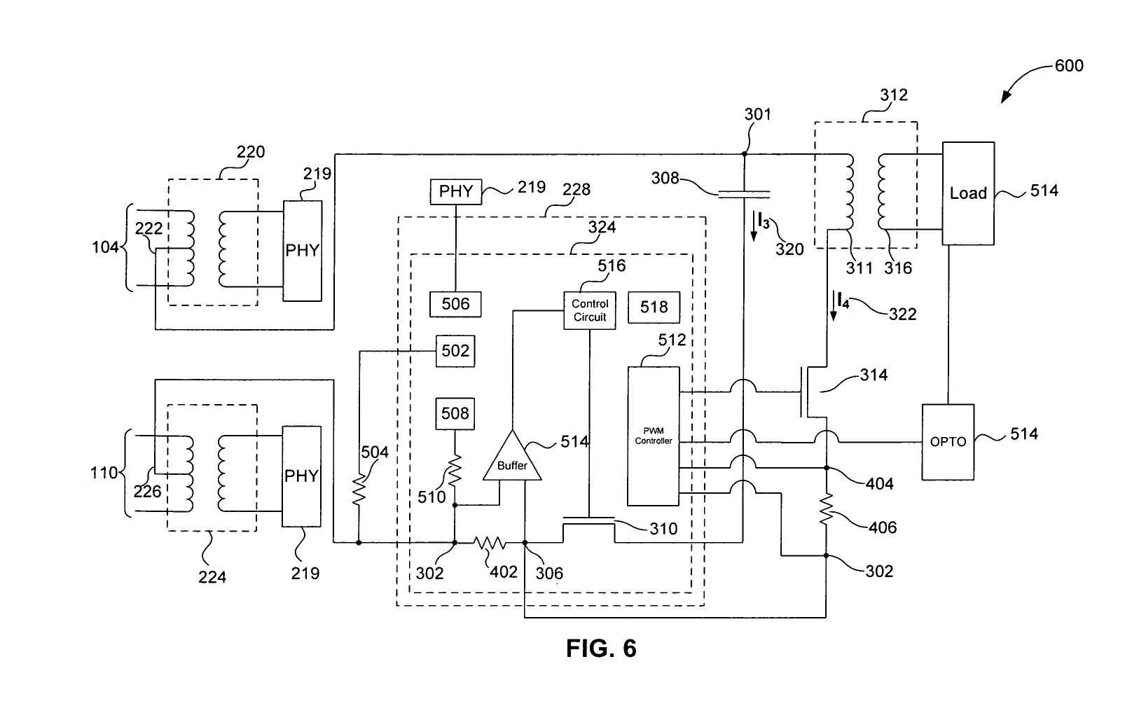

FIG. 6 illustrates another detailed exemplary embodiment of the PD 106 having a pulse width modulated (PWM) return circuit 600. The PWM return circuit 600 uses separate sensing resistors to sense the inrush current (I₃) 320 and the PWM current (I₄) 322. In this example, the PWM controller 512 is coupled to the fourth node 404 and the second node 302. Thus, the PWM controller 512 is coupled across the PWM sensing resistor 406 to measure a voltage across the PWM sensing resistor 406 in order to determine the magnitude of the PWM current (I₄) 322.

Initial coupling of the PSE 102 to the PD 106 initiates the following series of events. First, during a detection phase, the PD 106 provides a valid signature to the PSE 102 to verify that the PD 106 is a valid device. Second, during a classification phase, the PD 106 provides classification information to the PSE 102 to enable the PSE 102 to determine the power class of the PD 106. Third, during a power phase, the PD 106 receives power from the PSE 102.

In the detection phase, the PD 106 provides a valid signature to the PSE 102. After initial coupling of the PSE 102 to the PD 106, the PSE 102 provides a detection voltage to the PD 106 via the conductor pairs 104 and 110 to check for a valid signature. The PSE 102 measures a detection current associated with the detection voltage to determine validity of the signature. The signature resistor 510 determines the signature of the PD 106 and thus the detection current. In an example, initial coupling occurs when an Ethernet cable is plugged into both the PSE 102 and the PD 106.

During the detection phase, the hot-swap FET 310 and the PWM FET 314 resist current flow to minimize a possibility of inaccurate detection. The hot-swap FET 310 isolates the capacitor 308. The PWM FET 314 isolates the first winding 311. The hot-swap FET 310 and the PWM FET 314 isolate to minimize an effect of isolated components on the detection current which leads to inaccurate detection. If the PSE 102 detects the valid signature, the PSE 102 and the PD 106 proceed to the classification phase. If the PSE 102 does not detect the valid signature, then the PSE 102 and the PD 106 do not proceed to the classification phase. In an example, if the PSE 102 does not detect the valid signature, the PSE 102 may attempt to provide the detection signal and measure it multiple times before deciding not to proceed to the classification phase.

In the classification phase, the PD 106 provides classification information to the PSE 102 to enable the PSE 102 to determine the power class of the PD 106. The PSE 102 provides a classification voltage to the PD 106 via the conductor pairs 104 and 110. The PSE 102 measures a classification current associated with the classification voltage to determine the power class of the PD 106. The classification resistor 504 determines the classification current.

During the classification phase, the hot-swap FET 310 resists current flow to isolate the capacitor 308 and thus minimize a possibility of inaccurate classification. The PWM FET 314 also resists current flow to isolate the first winding 311 and thus minimize a possibility of inaccurate classification. After the PSE 102 detects the power class, the PSE 102 and the PD 106 proceed to the power phase.

Still referring to FIG. 6, in the power phase, the PD 106 receives power from the PSE 102. Upon application of power, the power phase has a transition period followed by a steady-state period. During the transition period, the hot-swap FET 310 conducts to charge the capacitor 308. The capacitor 308 charges through the first node 301, the hot-swap FET 310, and the second node 302. When the capacitor 308 charges during the transition period, the inrush current (I₃) 320 flows through the capacitor 308 and the hot-swap FET 310. In an example, the voltage between the first node 301 and the second node 302 is substantially 48 volts.

The inrush current (I₃) 320 flows through the inrush current sensing resistor 402. The buffer 514 senses the inrush current (I₃) 320 by sensing a voltage across the inrush current sensing resistor 402. The buffer 514 outputs a signal indicating a magnitude of the inrush current (I₃) 320 flow to the hot swap FET control circuit 516.

The hot swap FET control circuit 516 controls the conductivity of the hot swap FET 310. When the inrush current (I₃) 320 is high in magnitude, the hot swap FET control circuit 516 reduces the conductivity of the hot swap FET 310. Reducing the conductivity of the hot swap FET 310 reduces the magnitude of the inrush current (I₃) 320. Thus, the hot swap FET 310 limits the inrush current (I₃) 320. When the inrush current (I₃) 320 is low in magnitude, the hot swap FET control circuit 516 increases the conductivity of the hot swap FET 310. Increasing the conductivity of the hot swap FET 310 permits increases in the magnitude of the inrush current (I₃) 320. During the transition period, the PWM FET 314 resists current flow to reduce a charge time of the capacitor 308. In an example, the PWM FET 314 is off during the transition period. The inrush current (I₃) 320 limits are determined in part upon the capacitance of the capacitor 308.

The steady-state period follows the transition period. The steady-state period begins after the capacitor 308 substantially receives an initial charge. The control circuit 318 determines when the transition period ends and the steady-state period begins. The hot swap FET 310 conducts during the steady-state period to permit the capacitor 308 to maintain a substantially stable voltage across the PWM FET 314 and the first winding 311. In an example, the hot swap FET 310 is on during the steady-state period. The hot swap FET 310 does not control the PWM current (I₄) 322.

During the steady-state period, the PWM FET 314 pulse width modulates the PWM current (I₄) 322. The PWM controller 512 controls the PWM FET 314 to determine the pulse width of the PWM current (I₄) 322. Thus, during the steady-state period, the hot swap FET 310 conducts and the PWM FET 314 cycles. The PWM current (I₄) 322 flows through the center tap 222, the first winding 311, the PWM FET 314, and the center tap 226. The PWM current (I₄) 322 does not flow through the hot swap FET 310 thus reducing power dissipation of the powered device controller. Changes in the PWM current (I₄) 322 due to pulse width modulation vary a magnetic field in the load transformer 312, thus coupling energy to power the load 108.

The PWM current (I₄) 322 flows through the PWM sensing resistor 406. The buffer 514 measures a voltage across the PWM sensing resistor 406 to determine the magnitude of the PWM current (I₄) 322. The buffer 514 outputs a signal indicating a magnitude of the PWM current (I₄) 322 flow to the PWM controller 512. The opto-electric coupler 520 provides feedback about power consumption of the load 108 to the PWM controller 512 so the PWM controller 512 may respond to changes in power consumption. When the PD 106 is to be de-energized, both the hot swap FET 310 and the PWM FET 314 are actuated to resist current flow.

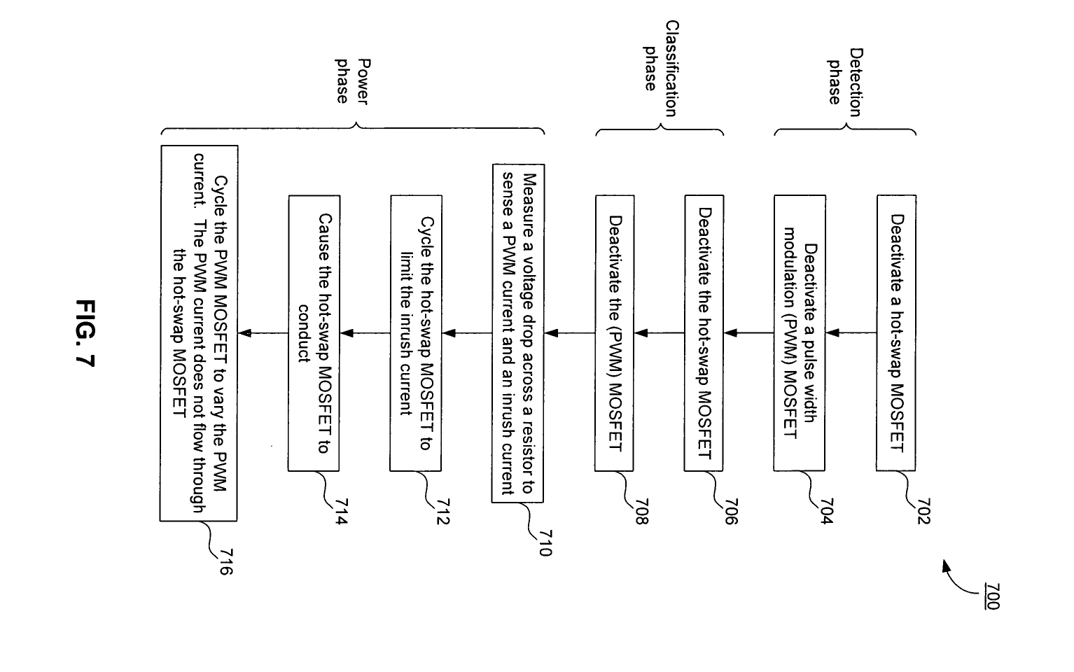

FIG. 7 shows an exemplary method to control a powered device 700. Steps 702 and 704 occur during the detection phase. In step 702, the hot-swap FET is deactivated. In step 704, the PWM FET is deactivated. Steps 706 and 708 occur during the classification phase. In step 706, the hot-swap FET is deactivated. In step 708, the PWM FET is deactivated.

Steps 710 through 716 occur during the power phase. In step 710, a voltage drop across a resistor is measured to sense a PWM current and an inrush current. In step 712, the hot-swap FET is actuated to reduce conductivity to limit the inrush current. In step 714, the hot-swap FET is actuated to increase conductivity. In step 716, the PWM FET is cycled to vary the PWM current. The PWM current does not flow through the hot-swap ET. In an example, steps 702 through 712 are optional.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A pulse width modulated return circuit for a powered device, comprising:
a first transformer having a first and second tap;
a sensing resistor coupled between said second tap and a node;
a capacitor and a first FET series coupled between said first tap and said node;
wherein said first FET is part of a powered device controller;
a second transformer having a winding; and
a second FET series coupled with said winding between said first tap and said node.

2. The circuit of claim 1, wherein said powered device controller includes a control circuit, further wherein said control circuit is coupled to at least one of a first FET gate, a second FET gate, said second tap, and said node.

3. The circuit of claim 1, wherein said powered device controller includes a detection circuit, further wherein said detection circuit is coupled to said second tap via a signature resistor.

4. The circuit of claim 1, wherein said powered device controller includes a classification circuit, further wherein said classification circuit is coupled to said second tap via a classification resistor.

5. The circuit of claim 1, wherein said powered device controller includes:
a pulse width modulation (PWM) controller; and
a buffer having a first input, a second input, and an output;
wherein said first input is coupled to said second tap, said second input is coupled to said node, and said output is coupled to said PWM controller.

6. The circuit of claim 1, wherein said powered device controller is deposited on a substrate.

7. A powered device controller, comprising:
a hot swap FET, wherein said hot swap FET does not control a pulse width modulated current;
a hot swap FET controller that senses a voltage across a sensing resistor to control said hot swap FET; and
a pulse width modulation (PWM) controller that senses said voltage to control a PWM FET;
wherein the powered device controller is deposited on a substrate.

8. A powered device controller, comprising:
a hot swap FET;
means for causing said hot-swap FET to conduct; and
means for cycling a pulse-width modulation (PWM) FET to vary a PWM current;
wherein said PWM current does not flow through said hot-swap FET.

9. The controller of claim 8, further comprising means for measuring a voltage across a resistor to sense both said PWM current and an inrush current.

10. The controller of claim 8, further comprising:
means for deactivating said hot-swap FET during a detection phase; and
means for deactivating said PWM FET during said detection phase.

11. The controller of claim 8, further comprising:
means for deactivating said hot-swap FET during a classification phase; and
means for deactivating said PWM FET during said classification phase.

12. The controller of claim 8, further comprising means for cycling said hot-swap FET to limit an inrush current.
